(19) United States
(12) Patent Application Publication
(10) Pub. No.: US 2019/0041190 A1
(43) Pub. Date: Feb. 7, 2019

(54) DIMENSION MEASUREMENT APPARATUS

(71) Applicant: TOSHIBA TEC KABUSHIKI KAISHA, Tokyo (JP)

(72) Inventor: Atsushi OKAMURA, Mishima Shizuoka (JP)

(21) Appl. No.: 16/037,387

(22) Filed: Jul. 17, 2018

(30) Foreign Application Priority Data
Aug. 3, 2017 (JP) 2017-150754

(51) Int. Cl. G01B 11/02; G06T 7/73; G01G 19/414; G06K 9/46; G01G 19/52

(52) U.S. Cl. CPC G01B 11/026; G06T 7/74; G01G 19/52; G01B 11/022; G06K 9/4642; G01G 19/4148

(57) ABSTRACT

In one embodiment, a dimension measurement apparatus has a camera a processing device. The processing device acquires a distance image of an object to be measured which is to be generated by the camera. The processing device divides the distance image into an X coordinate image, a Y coordinate image, and a Z coordinate image, removes a coordinate point not corresponding to one reference surface of the object to be measured, in the respective coordinate images, and detects coordinate images of the reference surface corresponding to the reference surface.

### CROSS-REFERENCE TO RELATED APPLICATION

This application is based upon and claims the benefit of priority from the prior Japanese Patent Application No. 2017-150754, filed on Aug. 3, 2017, the entire contents of which are incorporated herein by reference.

### FIELD

Embodiments described herein relate generally to a dimension measurement apparatus.

### BACKGROUND

At the time of accepting a transportation object in a home delivery business or the like, a work is performed in which a weight of the transportation object is measured by a scale, dimensions of a length, a width and a height of the transportation object are respectively measured by a tape measure or the like, and a transportation charge is determined based on the combination of the measured weight and dimensions. For the reason, a home delivery agent has to separately perform the dimension measurement and the weight measurement to the transportation object, and thereby there was a problem that the working efficiency is not good.

In contrast, an apparatus which photographs a transportation object using a distance image sensor (camera) to acquire a distance image, and measures dimensions of the transportation object based on the acquired distance image is thought of. It is possible to reduce a work to manually measure dimensions and a weight of the transportation object by using the apparatus like this.

On the other hand, it is necessary to complete the measurement quickly and accurately at the time of measuring dimensions of a transportation object at a transportation object acceptance site. However, in order to enable the quick and accurate measurement, an arithmetic unit with high processing performance is necessitated for the dimension measurement based on the distance image, and thereby an installation cost might be increased. Accordingly, it is desired to reduce a processing load for the dimension measurement based on the distance image so that the measurement can be completed quickly and accurately without increasing the installation cost.

### BRIEF DESCRIPTION OF THE DRAWINGS

FIG. 1 is a diagram showing an outer appearance of a dimension measurement apparatus according to an embodiment.

FIG. 2 is a block diagram showing a configuration of the dimension measurement apparatus according to the embodiment.

FIG. 3 is a block diagram showing a configuration of the processing device according to the embodiment.

FIG. 4 is a block diagram showing function modules to be realized by a dimension measurement program according to the embodiment.

FIG. 5 is a block diagram for describing the image processing module according to the embodiment.

FIG. 6 is a block diagram for describing the dimension data generation module according to the embodiment.

FIG. 7 is a diagram showing a position relation of the camera and the transportation object according to the embodiment.

FIG. 8 is a diagram showing a photographable range of the camera according to the embodiment.

FIG. 9 is a diagram in which the distance image according to the embodiment obtained by photographing the transportation object by the camera is expressed in an XYZ coordinate space.

FIG. 10 is a diagram for describing the closing processing according to the embodiment.

FIG. 11 is a diagram conceptually showing a rectangular solid having an upper surface which an upper surface 3D model indicates, based on the upper surface 3D model which the 3D modeling module according to the embodiment has generated.

FIG. 12 is a diagram showing a maximum value and a minimum value of a peak zone of a histogram distribution of the upper surface Z coordinate image which the histogram distribution generation module according to the embodiment has generated.

### DETAILED DESCRIPTION

According to one embodiment, a dimension measurement apparatus has a camera and a processing device. The camera photographs an object to be measured to generate a distance image of the object to be measured. The processing device has a memory and a controller so that the processing device generates dimension data indicating a length, a width, and a height of the object to be measured based on the distance image generated by the camera. The memory stores a control program for generating the dimension data. The controller acquires the distance image of the object to be measured. The controller divides the acquired distance image into an X coordinate image, a Y coordinate image, and a Z coordinate image in a three-dimensional space. The controller removes a coordinate point not corresponding to one reference surface of the object to be measured, in the respective divided X coordinate image, Y coordinate image, and Z coordinate image, to detect an X coordinate image, a Y coordinate image, and a Z coordinate image of the reference surface. Further, the controller generates the dimension data indicating the length, the width, and the height of the object to be measured, based on the respective detected coordinate images of the reference surface.

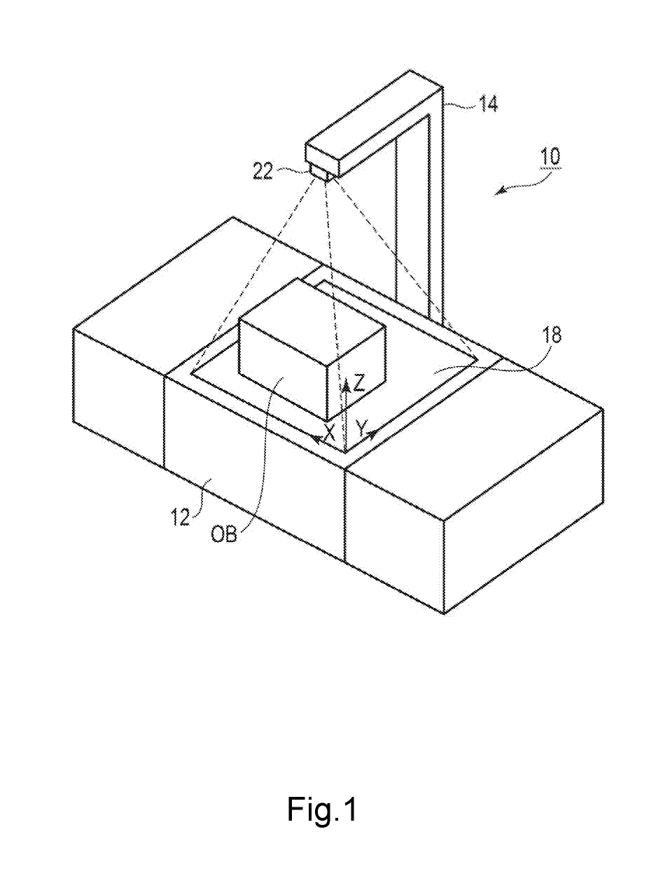

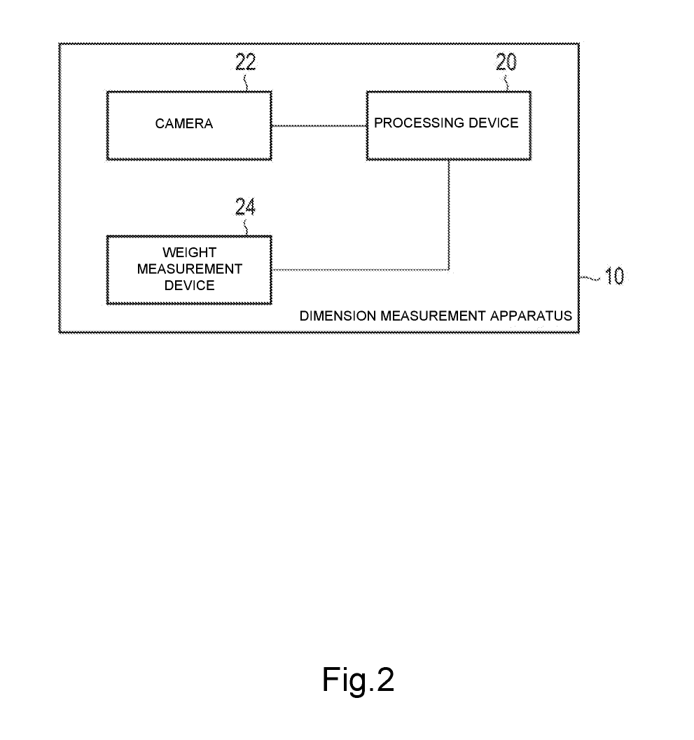

Hereinafter, the present embodiment will be described with reference to the drawings. In the drawings, the same symbols indicate the same or the similar portions. FIG. 1 is a diagram showing an outer appearance of a dimension measurement apparatus 10 according to the present embodiment. FIG. 2 is a block diagram showing a configuration of the dimension measurement apparatus 10 according to the present embodiment.

The dimension measurement apparatus 10 is installed and used at an acceptance place of a transportation object OB of a home delivery agent, for example. The dimension measurement apparatus 10 measures dimensions of a length, a width, and a height (a depth, a width, and a height), and a weight of the transportation object OB, in order to determine a transportation charge of the transportation object OB.

As shown in FIG. 1 and FIG. 2, the dimension measurement apparatus 10 has a measurement table 12, a camera 22, a weight measurement device 24, and a processing device 20. A measurement area 18 in which the transportation object OB that is an object to be measured is to be horizontally placed, for example, is provided on an upper surface of the measurement table 12. The camera 22 supported by a support member 14 is arranged above the measurement area 18. The camera 22 photographs the transportation object OB placed in the measurement area 18 from above to generate a distance image. The distance image is used in a processing to measure dimensions of the length, the width, and the height of the transportation object OB. The distance image is an image including values by which respective pixels of the image obtained by imaging the photographic subject indicate distances to the photographic subject.

The distance image generated by the camera 22 is expressed by point group data (XYZ coordinate image) including positions (XYZ coordinates) of respective pixels in an XYZ coordinate space. The XYZ coordinate space is defined by an orthogonal coordinate system using, as a reference, an origin which is set to any position within a space to be photographed by the camera 22, for example. In FIG. 1, the origin is defined to a position corresponding to one corner position of the rectangular measurement area 18, for example. An X coordinate axis and a Y coordinate axis are defined along sides of the measurement area 18. A Z coordinate axis is defined to an upward direction from the placing surface of the measurement area 18 on which the transportation object OB is to be placed. In the present embodiment, description will be made assuming that the length (depth), the width (width), and the height of the transportation object OB correspond respectively to the Y coordinate axis direction, the X coordinate axis direction, and the Z coordinate axis direction in the XYZ coordinate space.

The camera 22 may be a stereo camera to output a distance image based on parallax of the imaged images by two cameras, for example, or may be a distance image camera (sensor) of a TOF (Time Of Flight) system to measure a distance from a time required for a projected laser to reciprocate to a photographic subject. In addition, the camera 22 may be a camera to generate a distance image of another system.

In addition, the weight measurement device 24 is provided in the measurement area 18. The weight measurement device 24 measures a weight of the transportation object OB placed in the measurement area 18.

The processing device 20 inputs (acquires) the distance image (point group data) generated by the camera 22. The processing device 20 executes a dimension processing to generate dimension data indicating dimensions of the length, the width, and the height of the transportation object OB. In addition, the processing device 20 inputs the weight data measured by the weight measurement device 24. The processing device 20 executes a processing to calculate a transportation charge of the transportation object OB, using the inputted weight data and the generated dimension data.

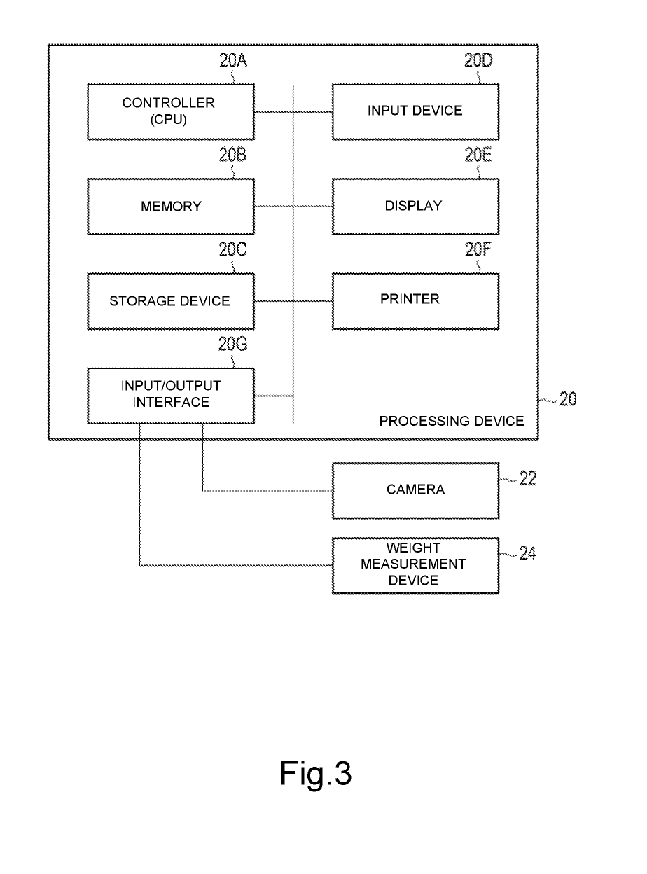

FIG. 3 is a block diagram showing the processing device 20 according to the present embodiment. The processing device 20 has a function of a computer. Specifically, the processing device 20 has a controller 20A, a memory 20B, a storage device 20C, an input device 20D, a display 20E, a printer 20F, and an input/output interface 20G.

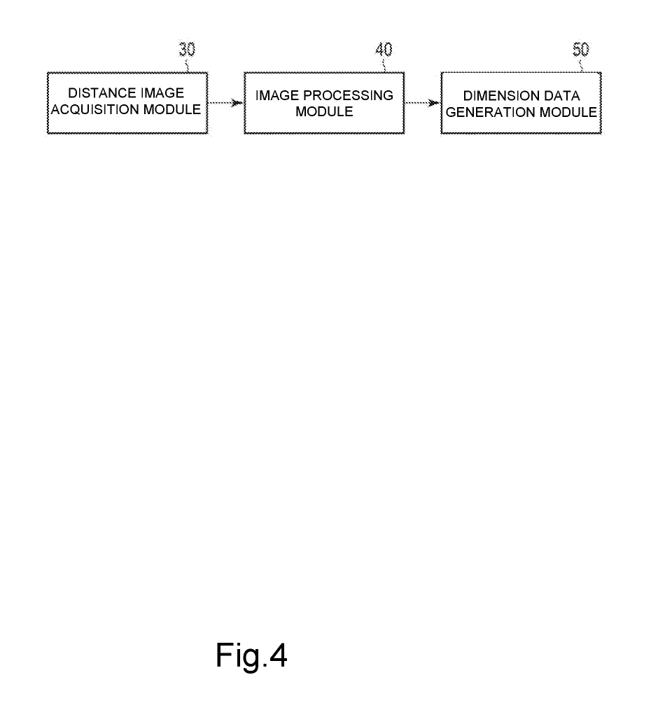

The controller 20A is a CPU (Central Processing Unit), for example. Hereinafter, the controller 20A may be called the CPU 20A. The CPU 20A executes a control program to control the whole of the dimension measurement apparatus 10. The control program includes a dimension measurement program and so on. The CPU 20A executes the dimension measurement program to realize function modules shown in a block diagram of FIG. 4. The function modules to be realized by the dimension measurement program include a distance image (point group data) acquisition module 30, an image processing module 40, and a dimension data generation module 50.

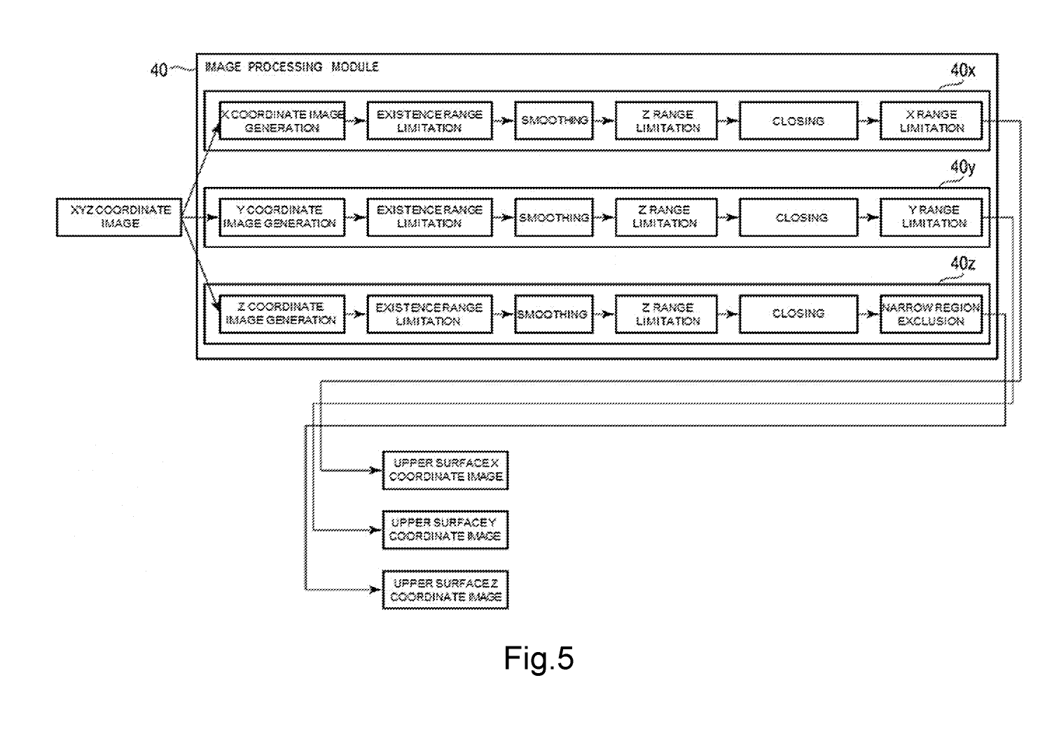

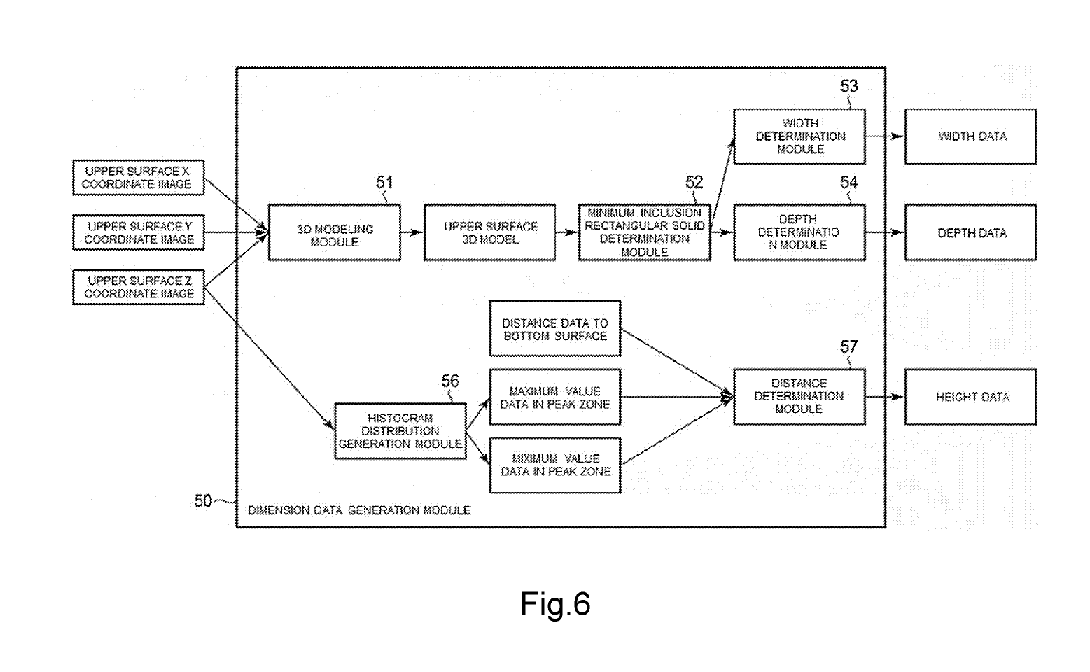

The distance image acquisition module 30 acquires the point group data (may be called the XYZ coordinate image) composed of positions (XYZ coordinates) of respective pixels in the XYZ coordinate space of the distance image of the transportation object OB photographed by the camera 22. The image processing module 40 generates an upper surface coordinate image corresponding to a reference surface of the transportation object OB, based on the distance image (XYZ coordinate image). In the present embodiment, the upper surface of the transportation object OB is made to be the reference surface. The image processing module 40 divides the distance image into an X coordinate image, a Y coordinate image, and a Z coordinate image, and removes coordinate points not corresponding to the upper surface (reference surface) of the transportation object OB in the respective coordinate images, to detect respective upper surface coordinate images corresponding to the upper surface (refer to FIG. 5). The dimension data generation module 50 generates dimension data indicating dimensions of the length, the width, and the height (depth, width, height) of the transportation object OB, based on the upper surface coordinate images (refer to FIG. 6).

The memory 20B stores various data associated with the execution of various processings, in addition to the respective control programs to be executed by the CPU 20A. The storage device 20C is a nonvolatile storage medium (a hard disk or the like), and stores various program and data.

The input device 20D inputs an instruction for controlling an operation of the dimension measurement apparatus 10. The input device 20D includes a touch panel, a keyboard, a button and so on, for example. The input device 20D detects an input of an instruction to the touch panel, the keyboard, the button and so on, and outputs (notifies) the instruction to the CPU 20A. For example, the input device 20D is installed (not shown) in the vicinity of the measurement table 12 shown in FIG. 1, and accepts an instruction of photographing start (dimension measurement start) to the transportation object OB by the camera 22.

The display 20E displays an operation state and a processing result of the dimension measurement apparatus 10 under the control of the CPU 20A. The display 20E is installed (not shown) in the vicinity of the measurement table 12, for example, and presents the operation state and the processing result to a home delivery agent (receptionist) working at the measurement table 12, or a customer. The printer 20F prints a charge and so on determined based on the measured dimensions and weight of the transportation object OB.

The input/output interface 20G is an interface to which the camera 22 and the weight measurement device 24 are to be connected. Another external device may be connected to the input/output interface 20G.

FIG. 5 is a block diagram for describing details of the image processing module 40. As shown in FIG. 5, the image processing module 40 includes an X coordinate image processing module 40x, a Y coordinate image processing module 40y, and a Z coordinate image processing module 40z.

The X coordinate image processing module 40x removes X coordinate points in the range not corresponding to the upper surface of the transportation object OB from the X coordinate image to generate an upper surface X coordinate image. The X coordinate image processing module 40x executes respective processings of an X coordinate image generation, an existence range limitation, smoothing, a Z range limitation, closing, an x range limitation, for example, to generate the upper surface X coordinate image.

The Y coordinate image processing module 40y removes Y coordinate points in the range not corresponding to the upper surface of the transportation object OB from the Y coordinate image to generate an upper surface Y coordinate image. The Y coordinate image processing module 40y executes respective processings of a Y coordinate image generation, the existence range limitation, the smoothing, the Z range limitation, the closing, a y range limitation, for example, to generate the upper surface Y coordinate image.

The Z coordinate image processing module 40z removes Z coordinate points in the range not corresponding to the upper surface of the transportation object OB from the Z coordinate image to generate an upper surface Z coordinate image. The Z coordinate image processing module 40z executes respective processings of a Z coordinate image generation, the existence range limitation, the smoothing, the Z range limitation, the closing, a narrow region exclusion, for example, to generate the upper surface Z coordinate image.

Each of the X coordinate image processing module 40x, the Y coordinate image processing module 40y, and the Z coordinate image processing module 40z limits the object to be processed to a range to be measured in the distance image generated by the camera 22 (corresponds to a range of the measurement area 18, for example), by the processing of the existence range limitation. Since each of the X coordinate image processing module 40x, the Y coordinate image processing module 40y, and the Z coordinate image processing module 40z makes, not the three-dimensional coordinate data, but only the coordinate data of the corresponding coordinate system, to be the object to be processed, the processing procedure is simplified and thereby the processing efficiency can be improved.

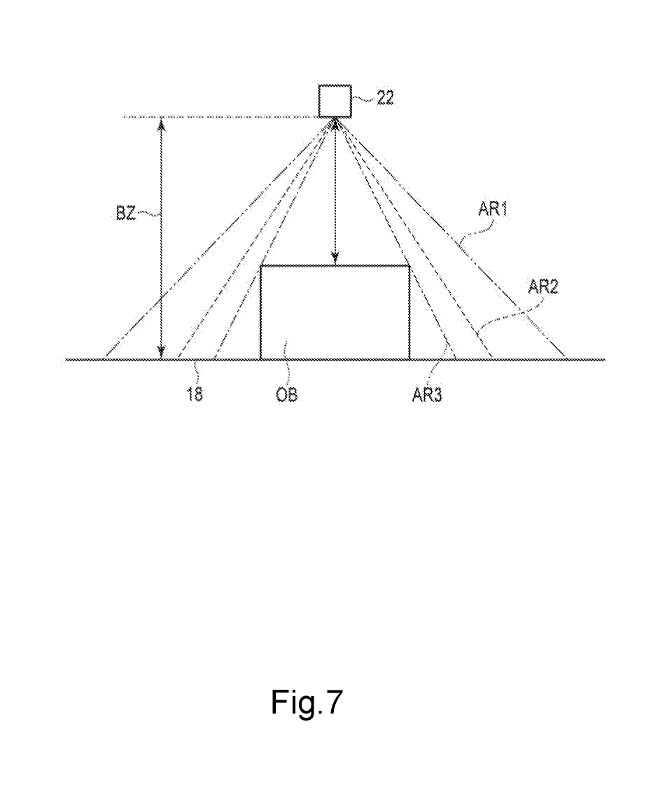

FIG. 7 is a diagram showing a position relation of the camera 22 and the transportation object OB in the present embodiment. As shown in FIG. 7, the camera 22 is arranged immediately above the measurement area 18 in which the transportation object OB is to be placed, for example, and photographs the transportation object OB. For example, a photographable range (an angle of view) by the camera 22 is made to be an area AR1, and the range to be measured (the measurement area 18) is made to be an area AR2.

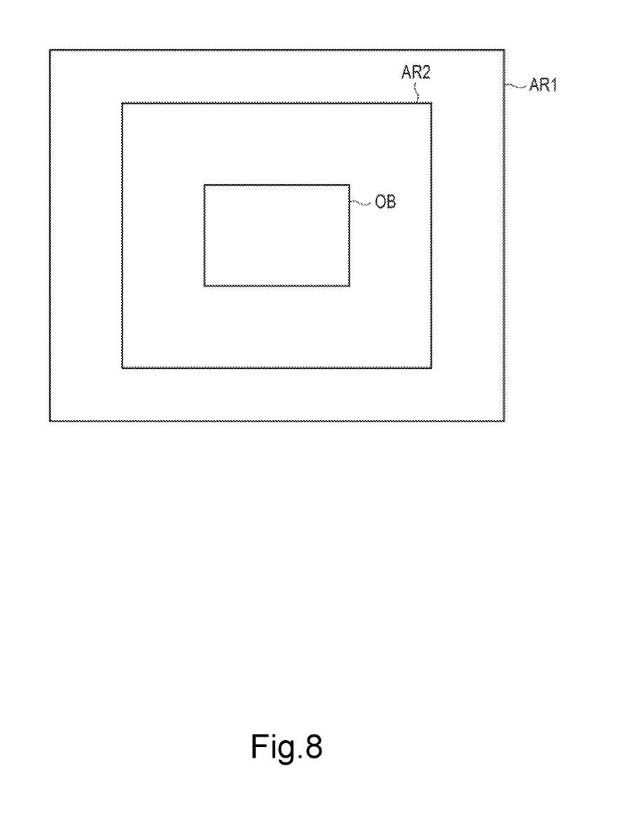

FIG. 8 shows the areas AR1, AR2 and an example of an arrangement of the transportation object OB. As shown in FIG. 8, when photographing is performed by the camera 22, a range including the area AR1 is photographed. Each of the X coordinate image processing module 40x, the Y coordinate image processing module 40y and the Z coordinate image processing module 40z limits the object to be processed to a range included in the area AR2 shown in FIG. 8, by the relevant processing of the existence range limitation. As shown in FIG. 8, when the transportation object OB is photographed in the state to be placed in the measurement area 18, the upper surface of the transportation object OB is included in the area AR2.

In addition, each of the X coordinate image processing module 40x, the Y coordinate image processing module 40y and the Z coordinate image processing module 40z limits only coordinate values of pixels having the Z coordinate values in the range capable of corresponding to the transportation object OB, as the object to be processed, by the relevant processing of the Z range limitation. For example, in the dimension measurement apparatus 10, a coordinate value of a pixel having a Z coordinate value exceeding an upper limit of the transportation object OB whose dimension is to be measured is removed as being outside the object to be processed.

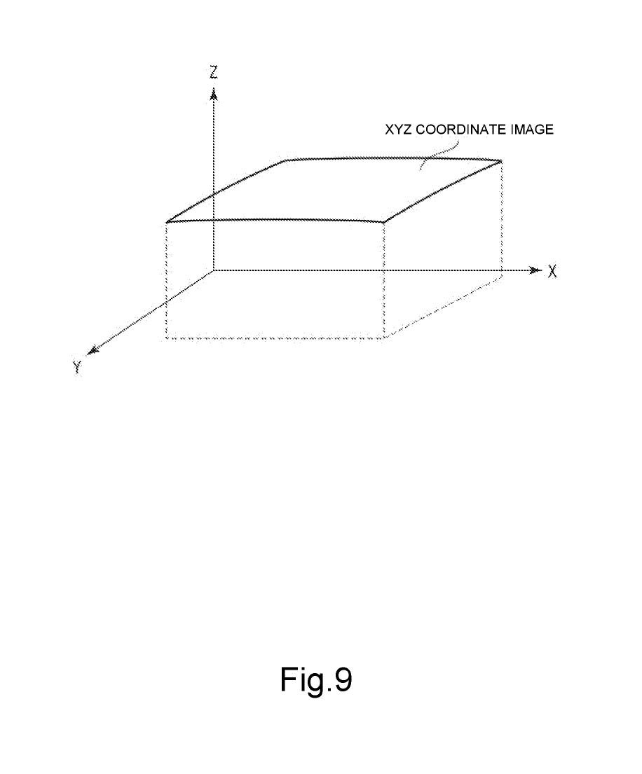

FIG. 9 is a diagram showing the distance image (XYZ coordinate image (dot group data)) generated when the camera 22 has photographed the transportation object OB in the XYZ coordinate space (three-dimensional space). In addition, setting of the origin position and definition of positive directions of the coordinate system in the XYZ coordinate space shown in FIG. 9 are examples, and other setting and definition may be used. For example, the origin position may be set to a part of the XYZ coordinate image, and the positive direction of the Z coordinate system may be defined to be a downward direction.

The X coordinate image processing module 40x, the Y coordinate image processing module 40y, and the Z coordinate image processing module 40z respectively perform the processings of the Z range limitation to the X coordinate image, the Y coordinate image, and the Z coordinate image corresponding to the XYZ coordinate image shown in FIG. 9. By this means, a coordinate value of a pixel having a Z coordinate value that is made to be outside the object to be processed is removed as being outside the object to be processed.

In addition, each of the X coordinate image processing module 40x, the Y coordinate image processing module 40y, and the Z coordinate image processing module 40z removes a trash portion in the image, such as an isolated point and a thin line in the relevant coordinate image by the closing processing.

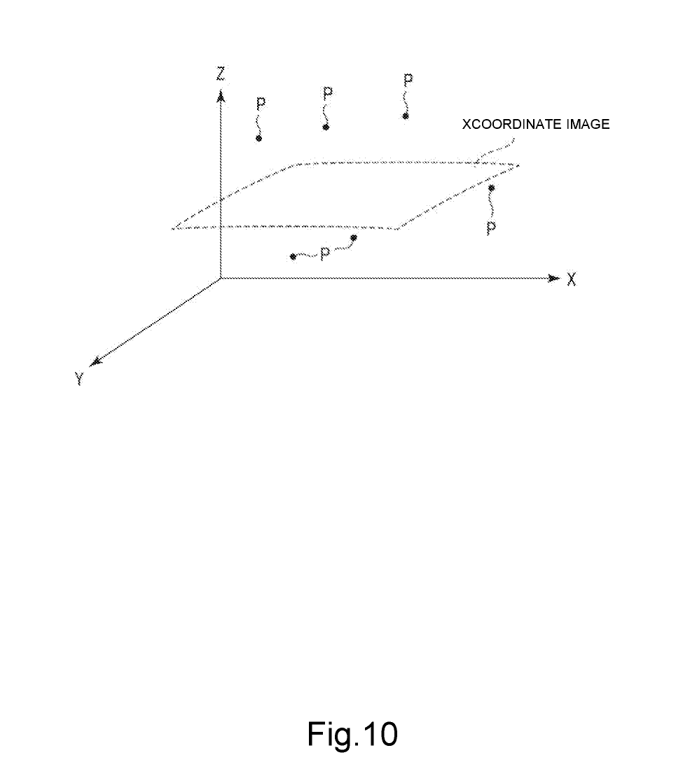

For example, the X coordinate image processing module 40x executes the closing processing to the X coordinate image shown in FIG. 10 to remove isolation point data P appearing as noise, for example, which does not correspond to the upper surface of the transportation object OB.

The X coordinate image processing module 40x limits the object to be processed to the data of the X coordinate in a range corresponding to the upper surface of the transportation object OB, by the processing of the x range limitation. In addition, the Y coordinate image processing module 40y limits the object to be processed to the data of the Y coordinate in a range corresponding to the upper surface of the transportation object OB, by the processing of the y range limitation. The Z coordinate image processing module 40z, when the Z coordinate data group (point group data) indicating a narrow region (narrow region) that is made not to correspond to a predetermined upper surface of the transportation object OB is present, removes the relevant coordinate data by the processing of the narrow region exclusion.

The image processing module 40 in the present embodiment, regarding the pixel position the coordinate point of which has been removed as being not corresponding to the upper surface in any one module of the X coordinate image processing module 40x, the Y coordinate image processing module 40y, and the Z coordinate image processing module 40z, makes the other coordinate image processing modules operate so as not to make the pixel position an object of the processing to remove the coordinate point. For example, the pixel position which has been removed by the processing based on the Z coordinate image by the Z coordinate image processing module 40z is made outside the object to be processed in the X coordinate image processing module 40x and the Y coordinate image processing module 40y, as the relevant pixel position has to be removed also in the X coordinate image and the Y coordinate image. When a coordinate value of one pixel is expressed by the XYZ coordinate, if the pixel is not discriminated as being the object to be removed in each of the X coordinate, the Y coordinate and the Z coordinate, the pixel cannot be discriminated as being the object to be removed. However, at a time point when the pixel is discriminated as being the object to be removed in any of the X coordinate, the Y coordinate and the Z coordinate, the image processing module 40 can discriminate the relevant pixel as being the object to be removed. By this means, it is possible to reduce the whole processing load in the image processing module 40.

In addition, at what timings the processings in the X coordinate image processing module 40x, the Y coordinate image processing module 40y, and the Z coordinate image processing module 40z are respectively executed is not particularly limited. For example, the processings in the X coordinate image processing module 40x, the Y coordinate image processing module 40y, and the Z coordinate image processing module 40z may be executed in series, and after the processing in the Z coordinate image processing module 40z has been executed, the processing of the X coordinate image processing module 40x and the processing of the Y coordinate image processing module 40y may be executed in parallel. In addition, when any image processing module finishes a processing in a certain stage, the processings using the result may be executed in parallel in the next image processing modules in a pipeline manner.

FIG. 6 is a block diagram for describing details of the dimension data generation module 50. As shown in FIG. 6, the dimension data generation module 50 has a 3D modeling module 51, a minimum inclusion rectangular solid determination module 52, a width determination module 53, a depth determination module 54, a histogram distribution generation module 56, and a distance determination module 57.

The 3D modeling module 51 generates an upper surface 3D model indicating the upper surface of the transportation object OB, based on the upper surface X coordinate image, the upper surface Y coordinate image, and the upper surface Z coordinate image to be obtained by the processing of the image processing module 40. The minimum inclusion rectangular solid determination module 52 discriminates a rectangular solid having the upper surface which the upper surface 3D model shows, that is, a rectangular solid indicating the upper surface of the transportation object OB photographed by the camera 22, based on the upper surface 3D model.

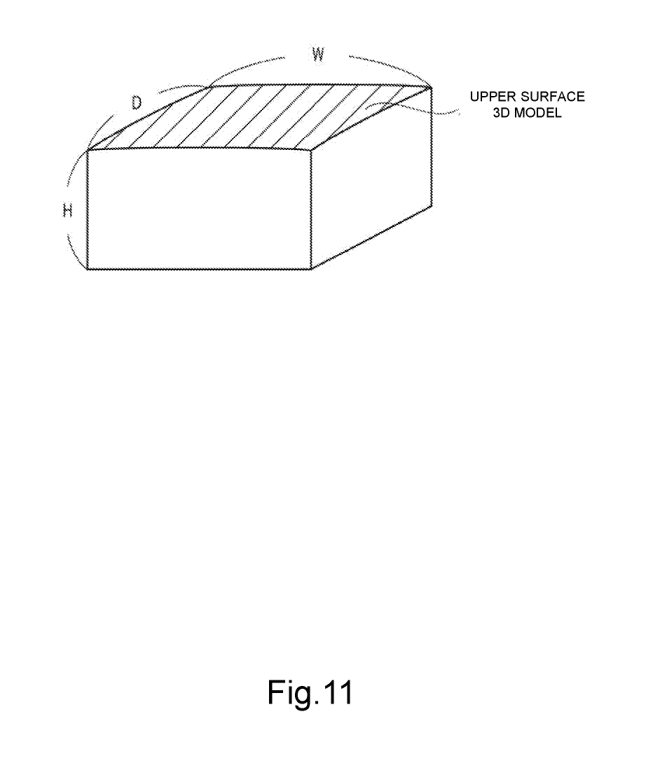

FIG. 11 is a diagram conceptually showing the rectangular solid having the upper surface which the upper surface 3D model shows. The transportation object OB is not actually a complete rectangular solid, but may be deformed, for example, the side surface or the upper surface may be expanded by a matter packed in the box, or may be dented by a weight applied from outside. In addition, there may be also a case in which an appendage is attached to the transportation object OB, for example, packing paper, an invoice, a seal or the like may be pasted, or a string for packaging may be wound. In the present embodiment, assuming that the transportation object OB in this state has a shape (an approximately rectangular solid) corresponding to a rectangular solid, a rectangular solid expressing the transportation object OB is discriminated based on the upper surface 3D model. The width determination module 53 determines a width (W) of the rectangular solid discriminated by the minimum inclusion rectangular solid determination module 52, that is, a dimension of the width of the upper surface of the transportation object OB, and outputs width data (lateral dimension data). The depth determination module 54 determines a depth (D) of the rectangular solid discriminated by the minimum inclusion rectangular solid determination module 52, that is, a dimension of the length of the upper surface of the transportation object OB, and outputs depth data (longitudinal dimension data).

The histogram distribution generation module 56 generates a histogram distribution indicating the number of pixels for each Z coordinate value, from the upper surface Z coordinate image obtained by the processing of the image processing module 40.

The distance determination module 57 determines a distance from the camera 22 to a position made to be the height of the upper surface of the transportation object OB, based on the histogram distribution of the upper surface Z coordinate image generated by the histogram distribution generation module 56, and determines a dimension of the height of the transportation object OB from the distance, and outputs height data. The distance determination module 57 determines a distance from the camera 22 to the position made to be the height of the upper surface of the transportation object OB, based on a maximum value (MaxPZ) of a peak zone of the histogram distribution of the upper surface Z coordinate image, a minimum value (MinPZ) of the peak zone of the histogram distribution of the upper surface Z coordinate image, and previously stored distance data indicating a distance from the camera 22 to the bottom surface of the transportation object OB (the upper surface of the measurement area 18).

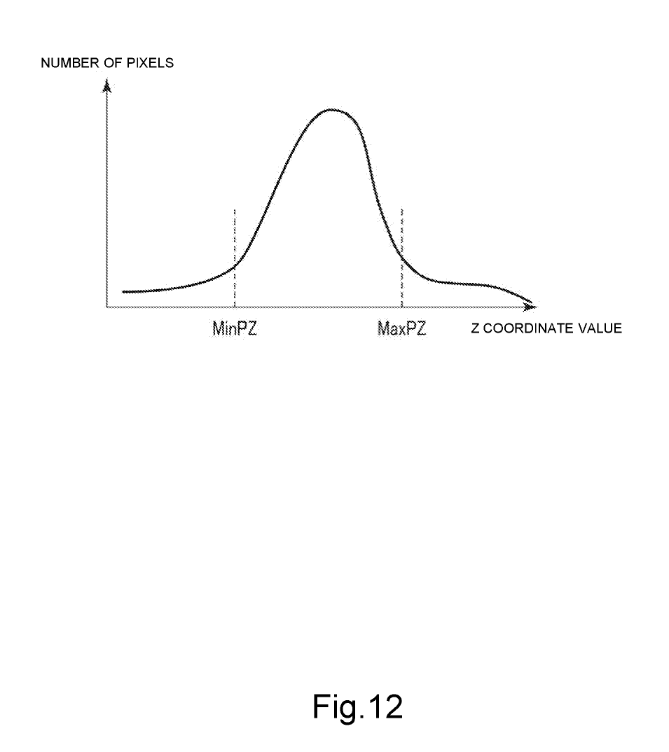

FIG. 12 is a diagram showing the maximum value (MaxPZ) and the minimum value (MinPZ) of the peak zone of the histogram distribution of the upper surface Z coordinate image.

The upper surface of the transportation object OB is not a plane due to an expansion, a dent, an appendage or the like as described above, but as shown in FIG. 12, pixels of distances included in a limited range concentrate. The distance determination module 57 determines a median, for example, to be the distance from the camera 22 to the upper surface of the transportation object OB, based on the maximum value and the minimum value of the peak zone corresponding to the limited range. The distance determination module 57 subtracts the distance determined based on the histogram distribution from a predetermined distance BZ from the camera 22 to the measurement area 18 (the placing surface of the transportation object OB) to calculate a distance corresponding to the height of the transportation object OB. The distance determination module 57 outputs height data in accordance with the distance corresponding to a height (H) of the transportation object OB.

Next, an operation of the dimension measurement apparatus 10 in the present embodiment will be described. For example, in order to determine a transportation charge of the transportation object OB, a dimension measurement and a weight measurement of the transportation object OB are performed using the dimension measurement apparatus 10. The transportation object OB is placed inside the measurement area 18 which is provided on the upper surface of the measurement table 12. Here, a dimension measurement start is instructed by an operation to the input device 20D, the processing device 20 instructs the camera 22 to photograph the transportation object OB, and instructs the weight measurement device 24 to execute the weight measurement.

The processing device 20 inputs the distance image (dot group data) generated by the camera 22, and in the image processing module 40, divides the distance image into the X coordinate image, the Y coordinate image, and the Z coordinate image, removes coordinate points not corresponding to the upper surface (reference surface) of the transportation object OB in the respective divided coordinate images, and thereby executes the processing to detect the respective upper surface coordinate images corresponding to the upper surface. The dimension data generation module 50 outputs the width data (lateral dimension data), the depth data (longitudinal dimension data), and the height data, as described above, by the processing based on the result of image processing by the image processing module 40.

The processing device 20 calculates a transportation charge, based on a sum of the dimensions of the length, the width, and the height of the transportation object OB which the data outputted by the dimension data generation module 50 indicates, the weight of the transportation object OB which the weight data to be inputted from the weight measurement device 24 indicates, a delivery destination (transportation distance) which is separately inputted through the input device 20D and so on, and a transportation mode (service contents). The calculated transportation charge is printed on a prescribed position of an invoice by the printer 20F, for example.

Since in the dimension measurement apparatus 10 in the present embodiment, the dimension measurement and the weight measurement are concurrently performed to the transportation object OB placed in the measurement area 18 in this manner, a working load for determining the transportation charge can be reduced. In the dimension measurement, the shape of the transportation object OB is specified and the dimension of the transportation object OB is measured, by only the distance image obtained by photographing the upper surface of the transportation object OB, and accordingly, the dimension can be measured simply and with high accuracy, without photographing the transportation object OB for a plural number of times while changing a position and an angle.

In addition, in the processing in the processing device 20, the distance image of the upper surface is divided into the X coordinate image, the Y coordinate image, and the Z coordinate image, and the processings are individually performed to the respective divided coordinate images, and thereby the processing load of the dimension measurement based on the distance image can be reduced. Accordingly, since an arithmetic unit with a high processing performance is not necessitated, increase in cost of the dimension measurement apparatus 10 can be avoided.

In addition, in the above-described description, the camera 22 is provided at a position immediately above the measurement area 18, but since at least the upper surface (reference surface) of the transportation object OB can only be photographed by the camera 22, the upper surface of the transportation object OB may be photographed obliquely from above, for example.

Further, in the above-described description, the camera 22 is installed above the measurement area 18, and thereby the distance image using the upper surface of the transportation object OB (the object to be measured) as the reference surface is acquired, but the transportation object OB is photographed from the lateral direction or from the downward direction of the transportation object OB, and thereby the distance image using the side surface or the bottom surface as the reference surface may be acquired. In this case, the camera 22 is installed at a position where the side surface or the bottom surface of the transportation object OB becomes photographable, and the transportation object OB is photographed from the lateral direction or the downward direction. In addition, when the transportation object OB is photographed from the lateral direction, the transportation object OB is placed in the measurement area 18, while a side surface opposite to a surface of the transportation object OB to be photographed is matched to a reference position (a wall formed vertically on the measurement area 18, for example). In addition, data indicating a distance from the camera 22 to the reference position (data corresponding to the above-described distance data BZ from the camera 22 to the bottom surface) is to be previously stored in the same manner as the above-described case in which the measurement area 18 is installed on the measurement table 12. Similarly, when the transportation object OB is photographed from the downward direction, data indicating a distance from the camera 22 provided below the measurement area 18 to the upper surface of the transportation object OB is to be previously stored (in this case, the placing surface of the measurement area 18 is to be formed of a transparent member).

In addition, in the above-described description, the dimension data of the transportation object OB is generated based on the distance image of one reference surface which has been acquired by photographing the transportation object OB from one direction, but the dimension data may be generated based on the distance images of a plurality of the reference surfaces photographed from a plurality of directions (the distance images obtained by photographing the upper surface and the side surface of the transportation object OB, for example). For example, an average value of the dimension data generated based on the respective distance images may be made to be final dimension data, or any effective dimension data may be selected. By this means, it becomes possible to generate the dimension data with higher accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A dimension measurement apparatus, comprising:
a camera which photographs an object to be measured to generate a distance image of the object to be measured; and
a processing device which generates dimension data indicating a length, a width, and a height of the object to be measured, based on the distance image generated by the camera;
the processing device having a memory to store a control program for generating the dimension data and a controller;
the controller executing the control program,
to acquire the distance image of the object to be measured,
to divide the acquired distance image into an X coordinate image, a Y coordinate image, and a Z coordinate image in a three-dimensional space,
to remove a coordinate point not corresponding to one reference surface of the object to be measured, in the respective divided X coordinate image, Y coordinate image, and Z coordinate image, to detect an X coordinate image, a Y coordinate image, and a Z coordinate image of the reference surface, and
to generate the dimension data indicating the length, the width, and the height of the object to be measured, based on the respective detected coordinate images of the reference surface.

2. The dimension measurement apparatus according to claim 1, wherein:
the controller performs an X coordinate image processing which removes an X coordinate point in a range not corresponding to the reference surface from the divided X coordinate image, to generate the X coordinate image of the reference surface;
the controller performs a Y coordinate image processing which removes a Y coordinate point in a range not corresponding to the reference surface from the divided Y coordinate image, to generate the Y coordinate image of the reference surface; and
the controller performs a Z coordinate image processing which removes a Z coordinate point in a range not corresponding to the reference surface from the divided Z coordinate image, to generate the Z coordinate image of the reference surface.

3. The dimension measurement apparatus according to claim 2, wherein regarding a pixel position a coordinate point of which has been removed in any one of the X coordinate image processing, the Y coordinate image processing, and the Z coordinate image processing, the controller does not make the pixel position an object of a processing to remove the coordinate point, but performs the other coordinate image processing.

4. The dimension measurement apparatus according to claim 2, wherein the controller generates the dimension data indicating the height of the object to be measured, based on a histogram of a Z coordinate value based on the Z coordinate image of the reference surface.

5. The dimension measurement apparatus according to claim 1, further comprising:
a weight measurement device which measures a weight of the object to be measured to generate weight data;
wherein the controller inputs the weight data of the object to be measured which has been generated by the weight measurement device, and calculates a transportation charge of the object to be measured, based on the dimension data and the weight data of the object to be measured.

6. A control method of a dimension measurement apparatus having a camera which photographs an object to be measured to generate a distance image of the object to be measured, comprising:
acquiring the distance image of the object to be measured which has been generated by the camera;
dividing the acquired distance image into an X coordinate image, a Y coordinate image, and a Z coordinate image in a three-dimensional space;
removing a coordinate point not corresponding to one reference surface of the object to be measured, in the respective divided X coordinate image, Y coordinate image, and Z coordinate image, to detect an X coordinate image, a Y coordinate image, and a Z coordinate image of the reference surface; and
generating dimension data indicating a length, a width, and a height of the object to be measured, based on the respective detected coordinate images of the reference surface.

7. The control method of a dimension measurement apparatus according to claim 6, wherein:
the detection of the X coordinate image of the reference surface includes to perform an X coordinate image processing which removes an X coordinate point in a range not corresponding to the reference surface from the divided X coordinate image, to generate the X coordinate image of the reference surface;
the detection of the Y coordinate image of the reference surface includes to perform a Y coordinate image processing which removes a Y coordinate point in a range not corresponding to the reference surface from the divided Y coordinate image, to generate the Y coordinate image of the reference surface; and
the detection of the Z coordinate image of the reference surface includes to perform a Z coordinate image processing which removes a Z coordinate point in a range not corresponding to the reference surface from the divided Z coordinate image, to generate the Z coordinate image of the reference surface.

8. The control method of a dimension measurement apparatus according to claim 7, wherein the detection of each of the coordinate images of the reference surface includes, regarding a pixel position a coordinate point of which has been removed in any one of the X coordinate image processing, the Y coordinate image processing, and the Z coordinate image processing, not to make the pixel position an object of a processing to remove the coordinate point, but to perform the other coordinate image processing.

9. The control method of a dimension measurement apparatus according to claim 7, wherein the generation of the dimension data includes to generate the dimension data indicating the height of the object to be measured, based on a histogram of a Z coordinate value based on the Z coordinate image of the reference surface.

10. The control method of a dimension measurement apparatus according to claim 7, further comprising:
inputting weight data of the object to be measured which has been generated by a weight measurement device to measure a weight of the object to be measured; and
calculating a transportation charge of the object to be measured, based on the dimension data and the weight data of the object to be measured.
